(19) United States
(12) Patent Application Publication
(10) Pub. No.: US 2008/0044704 A1
(43) Pub. Date: Feb. 21, 2008

(54) Fuel Cell System

(76) Inventors: Hidehito Kubo, Kariya-shi (JP); Daigoro Mori, Mishima-shi (JP)

Correspondence Address: MORGAN & FINNEGAN, L.L.P., 3 WORLD FINANCIAL CENTER, NEW YORK, NY, 10281-2101, US

(21) Appl. No.: 11/659,897

(22) PCT Filed: Dec. 22, 2005
(86) PCT No.: PCT/JP05/23607

§ 371 Date: Feb. 9, 2007

(30) Foreign Application Priority Data
Dec. 24, 2004 (JP) 2004-374356

(51) Int. Cl. H01M 8/04; F17C 11/00; F17C 7/00; H01M 8/10; H01M 8/00

(52) U.S. Cl. 429/24

(57) ABSTRACT

In a fuel cell system 10, hydrogen is supplied to a fuel cell 11 from a hydrogen storage tank 12 provided with a hydrogen-absorbing alloy MH and a heat exchanger 18. In this process, the pressure in the hydrogen storage tank 12 is held at a level equal to or higher than a predetermined pressure by using a heat medium that cooled the fuel cell 11. When the temperature of the hydrogen supplied to the fuel cell 11 is at the predetermined temperature or below, a control device 30 controls, based on a detection signal provided from a temperature sensor 23, first to fourth electromagnetic valves V1 to V4 so that the heat medium after having cooled the fuel cell 11 is supplied to the heat exchanger 18.

### TECHNICAL FIELD

The present invention relates to a fuel cell system, and more particularly, to a fuel cell system in which hydrogen is supplied from a hydrogen storage tank containing a hydrogen storage member to a fuel cell, a heat medium used to cool the fuel cell and to heat the hydrogen storage member, with pressure in the tank maintained to be greater than or equal to the pressure necessary to supply hydrogen to the fuel cell.

### BACKGROUND ART

With enhanced awareness of global warming prevention in recent years, to reduce carbon dioxide emissions from vehicles, electric vehicles using fuel cell systems and home power supplies fuel cell systems have been developed. In such a fuel cell system, hydrogen is supplied as a fuel gas from a hydrogen storage tank to a fuel cell.

A hydrogen storage alloy, which stores hydrogen as a hydride under a certain temperature and pressure conditions and releases hydrogen under different temperature and pressure conditions, has gained attention as a means for storing or transferring hydrogen. If the volumetric capacity were to be the same, the hydrogen storage alloy enables storage of a much greater amount of hydrogen than when storing hydrogen stored in a gaseous state.

In the fuel cell system, the fuel cell (e.g. solid polymer fuel cell) generates power while causing an exothermic reaction. Thus, the fuel cell needs to be cooled. Further, when hydrogen is supplied to the fuel cell using the hydrogen storage alloy in the hydrogen storage tank, the hydrogen storage alloy releases hydrogen while causing an endothermic reaction. Thus, the hydrogen storage alloy in the tank needs to be heated.

For example, patent publication 1 discloses a structure in which a heat medium circulating system for cooling a fuel cell also functions as a heat medium circulating system for heating a hydrogen storage alloy. In the structure, supply of the heat medium to the hydrogen storage tank is controlled to keep the pressure in the hydrogen storage tank greater than or equal to the pressure necessary to supply hydrogen to the fuel cell.

Further, patent publication 2 discloses charging hydrogen gas into the space in a hydrogen storage tank at a pressure exceeding a plateau pressure of a hydrogen storage alloy corresponding to a temperature in the tank. In this case, the charging pressure of hydrogen in the hydrogen storage tank is preferably in a range of 25 to 50 MPa.

Patent Publication 1: Japanese Laid-Open Patent Publication No. 5-251105

Patent Publication 2: Japanese Laid-Open Patent Publication No. 2004-108570

### DISCLOSURE OF THE INVENTION

The hydrogen storage tank may be a hybrid tank for holding hydrogen in a state in which the hydrogen is stored in a hydrogen storage alloy and in a state in which the hydrogen is charged into the space in the tank at a pressure exceeding the plateau pressure. In such a case, hydrogen is not released from the hydrogen storage alloy if the pressure in the hydrogen storage tank is greater than or equal to the plateau pressure when the tank is fully charged with hydrogen. When hydrogen is supplied, the pressure in the hydrogen storage tank is adjusted at a predetermined pressure, and hydrogen charged in the space in the hydrogen storage tank is supplied to the fuel cell. In this case, hydrogen supplied to the fuel cell undergoes adiabatic expansion, and the temperature of the hydrogen decreases.

At an oxygen electrode of the fuel cell, hydrogen and oxygen react with each other to form water, and some of the water vaporizes. The vapor may flow from the oxygen electrode through an electrolyte membrane and into a hydrogen electrode. When the fuel cell is a solid polymer fuel cell, the electrolyte membrane is maintained in a wet state to permit passage of hydrogen ions. For such reasons, when, for example, the ambient temperature is below zero degrees Celsius, the temperature of the hydrogen supplied to the hydrogen electrode decreases and causes water existing on the hydrogen reaction surface of the fuel cell to freeze. This may close the hydrogen passage of the fuel cell.

The flow amount or the temperature of a cooling medium is adjusted to maintain the fuel cell at temperatures at which its power generation efficiency is high (60 to 80° C.) during normal operation of the fuel cell. However, when, for example, the fuel cell is not warm, the temperature of the hydrogen supplied to the fuel cell may decrease and the temperature of the hydrogen reaction surface may decrease. This may lower the power generation efficiency of the fuel cell.

Accordingly, it is an object of the present invention to provide a fuel cell system that prevents power generation efficiency of a fuel cell from being lowered when the operation temperature of the fuel cell decreases, while preventing the water existing on a hydrogen reaction surface of the fuel cell from freezing so that a hydrogen passage of the fuel cell does not close.

To solve the above problems, one aspect of the present invention, is a fuel cell system in which hydrogen is supplied to a fuel cell from a hydrogen storage tank containing a hydrogen storage member in a tank main body, a heat medium that has cooled the fuel cell is used to heat the hydrogen storage member, and pressure in the tank main body is maintained to be greater than or equal to the pressure necessary to supply hydrogen to the fuel cell. A heat exchanger is arranged in the hydrogen storage tank. A heat medium passage supplies the heat medium to the heat exchanger. A temperature detection means detects temperature of the hydrogen supplied to the fuel cell. A switching means, arranged on the heat medium passage, switches between a state in which the heat medium that has cooled the fuel cell is supplied to the heat exchanger and a state in which the heat medium bypasses the heat exchanger. A control means controls the switching means based on a signal provided from the temperature detection means. The control means controls the switching means so that the heat medium that cooled the fuel cell is supplied to the heat exchanger when the temperature of the hydrogen supplied to the fuel cell is less than or equal to a predetermined temperature.

With the above structure, the heat medium that has cooled the fuel cell is supplied to the heat exchanger to heat the hydrogen storage tank based on the temperature of hydrogen supplied to the fuel cell. This prevents the temperature of hydrogen supplied to the fuel cell from becoming excessively low. As a result, the operation temperature of the fuel cell is prevented from becoming low, and the power generation efficiency of the fuel cell is prevented from decreasing. This prevents water on the hydrogen reaction surface of the fuel cell from freezing so that the hydrogen passage is not closed.

In the fuel cell system, it is preferred that the predetermined temperature is set at a temperature in which water on a hydrogen reaction surface of the fuel cell freezes. This further prevents water on the hydrogen reaction surface from freezing so that the hydrogen passage is not closed.

The fuel cell system preferably includes a plurality of hydrogen storage tanks. Hydrogen is supplied from each hydrogen storage tank to the fuel cell through a common pipe. The temperature detection means detects the temperature of the hydrogen flowing between the fuel cell and a portion of the pipe connected to each hydrogen storage tank. This detects the temperature of hydrogen supplied from each hydrogen storage tank to the fuel cell with high accuracy using the single temperature detection means.

In the fuel cell system, it is preferred that the heat medium that has cooled the fuel cell be supplied to the hydrogen storage member after passing through the vicinity of a hydrogen outlet for the hydrogen storage tank. This heats the vicinity of the hydrogen outlet for the hydrogen storage tank before the hydrogen storage member is heated. Thus, hydrogen supplied from the hydrogen storage tank to the fuel cell is heated more efficiently.

In the fuel cell system, it is preferred that the switching means is switchable between a state in which the heat medium that has cooled the fuel cell is sequentially supplied to each heat exchanger and a state in which the heat medium is supplied to a specific one of the heat exchangers. With this structure, when the fuel cell system includes a plurality of hydrogen storage tanks, all of the hydrogen storage tanks may be simultaneously heated or a specific one of the hydrogen storage tanks may be selectively heated.

In the fuel cell system, it is preferred that each hydrogen storage tank has a valve, and the controller controls the valve of each hydrogen storage tank to open and close in a manner that a residual amount of hydrogen in each of the hydrogen storage tanks is the same when supplying the fuel cell with hydrogen. With this structure, the residual amount of hydrogen in each hydrogen storage tank becomes substantially the same. This simplifies the control associated with heating of the hydrogen storage member in each hydrogen storage tank, that is, the supply of the heat medium to each heat exchanger.

In the fuel cell system, it is preferred that the controller controls the valve of each hydrogen storage tank to open and close in a manner that when the fuel cell has been supplied with hydrogen from one of the hydrogen storage tanks for a predetermined time, another one of the hydrogen storage tanks then supplies the fuel cell with hydrogen. This further simplifies the control associated with the supply of the heat medium to each hydrogen storage tank.

In the fuel cell system, it is preferred that the fuel cell system be installed in a fuel cell driven automobile. This stabilizes the driving state of the fuel cell driven automobile irrespective of, for example, the ambient temperature.

### BRIEF DESCRIPTION OF THE DRAWINGS

FIG. 1 is a schematic view showing the structure of a fuel cell system according to a first embodiment of the present invention;

FIG. 2 is a schematic view showing the structure of a fuel cell system according to a second embodiment of the present invention;

FIG. 3 is a schematic view showing the structure of a fuel cell system according to a third embodiment of the present invention;

FIG. 4 is a schematic cross-sectional view showing a hydrogen storage tank according to a further embodiment of the present invention; and

FIG. 5 is a schematic cross-sectional view showing a hydrogen storage tank according to a further embodiment of the present invention.

### BEST MODE FOR CARRYING OUT THE INVENTION

### First Embodiment

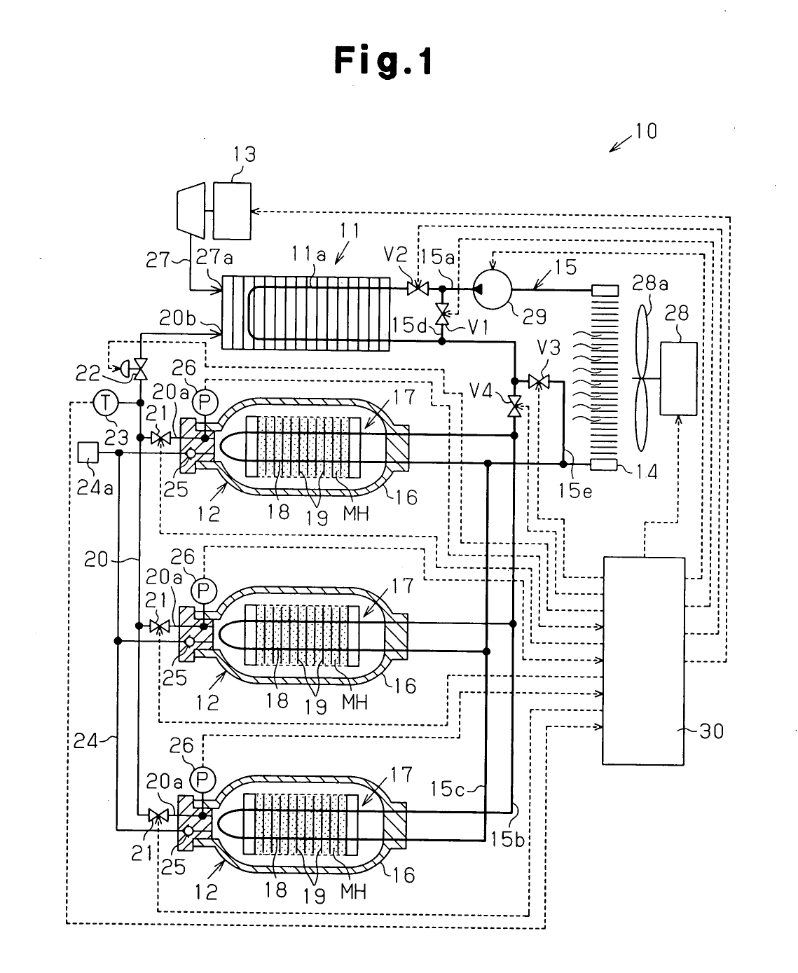

A fuel cell system 10 according to a first embodiment of the present invention will now be described with reference to FIG. 1.

The fuel cell system 10 includes a fuel cell 11, three hydrogen storage tanks 12, a compressor 13, and a radiator 14. The fuel cell 11, the hydrogen storage tanks 12, and the radiator 14 are connected to one another by a heat medium passage 15. In the present embodiment, a long life coolant (LLC) is used as a heat medium that flows through the heat medium passage 15.

The fuel cell 11 is a solid polymer fuel cell. The fuel cell 11 generates direct-current electric energy (direct-current power) by causing hydrogen supplied from each hydrogen storage tank 12 to react with oxygen contained in the air supplied from the compressor 13. The fuel cell 11 includes a heat exchanger 11a for cooling the fuel cell 11 during operation. In the present embodiment, the heat exchanger 11a forms part of the heat medium passage 15.

Each hydrogen storage tank 12 includes a tank main body 16, in which a hydrogen storage unit 17 is arranged. The hydrogen storage unit 17 contains a known hydrogen storage alloy MH, which functions as a hydrogen storage member. A heat exchanger 18 for exchanging heat with the hydrogen storage alloy MH is arranged in each hydrogen storage tank 12. The heat exchanger 18 has a large number of fins 19 for efficiently exchanging heat with the hydrogen storage alloy MH. In the preferred embodiment, the heat exchanger 18 forms part of the hydrogen storage unit 17 and part of the heat medium passage 15.

The hydrogen storage tanks 12 are connected to a hydrogen supply port 20b of the fuel cell 11 by a common pipe 20. A valve 21 is arranged in a connection portion 20a connecting the pipe 20 and each hydrogen storage tank 12. A pressure regulation valve 22 is arranged in the pipe 20 at a position downstream from the connection portions 20a. When each hydrogen storage tank 12 is in a fully charged state, the charged hydrogen in the hydrogen storage tank 12 has a pressure higher than the pressure in a plateau region of the hydrogen storage alloy MH (plateau pressure) (e.g. about 35 MPa). When hydrogen is supplied, the pressure regulation valve 22 adjusts the pressure of the hydrogen supplied to the fuel cell 11 to a predetermined pressure (e.g. about 0.3 MPa). Further, a temperature sensor 23, which functions as a temperature detection means, is arranged on the pipe 20 at a position downstream from the connection portions 20a. The temperature sensor 23 detects the temperature of the hydrogen supplied from the hydrogen storage tank 12 to the fuel cell 11.

Each hydrogen storage tank 12 is connected to a pipeline 24 having a hydrogen inlet 24a. Hydrogen gas is charged into each hydrogen storage tank 12, for example, from a hydrogen station through the pipeline 24. A check valve 25 and a pressure sensor 26 are arranged in each hydrogen storage tank 12. The check valve 25 prevents the hydrogen flowing in the pipe 20 from flowing back into the hydrogen storage tanks 12 via the pipeline 24. The pressure sensor 26 detects the pressure in the hydrogen storage tank 12.

The compressor 13 is connected to an oxygen supply port 27a of the fuel cell 11 by a pipeline 27. Compressed air (oxygen) is supplied from the compressor 13 to the fuel cell 11 through the pipeline 27. The compressor 13 includes an air cleaner, which is not shown, and discharges clean air in a compressed state into the pipeline 27.

A fan 28a, which is rotated by driving a motor 28, is arranged in the vicinity of the radiator 14. The fan 28a rotates and cools the heat medium passing through the radiator 14. The heat medium passage 15 includes a first portion 15a, which connects an inlet of the heat exchanger 11a of the fuel cell 11 and an outlet of the radiator 14, a second portion 15b, which connects an outlet of the heat exchanger 11a and an inlet of the heat exchanger 18 in each hydrogen storage tank 12, and a third portion 15c, which connects an outlet of each heat exchanger 18 and an inlet of the radiator 14.

A pump 29 is arranged in the first portion 15a. A bypass portion 15d, which branches from the first portion 15a and connects to the second portion 15b, is arranged on the first portion 15a downstream from the pump 29. A first electromagnetic valve V1 is arranged in the bypass portion 15d. A second electromagnetic valve V2 is arranged in the first portion 15a downstream from the branched portion. The first and second electromagnetic valves V1 and V2 are used to switch between a state in which the heat medium discharged from the pump 29 is supplied to the heat exchanger 11a and a state in which the heat medium bypasses the heat exchanger 11a.

A bypass portion 15e, which branches from the second portion 15b and connects to the third portion 15c, is arranged on the second portion 15b upstream from a portion branched to the most upstream heat exchanger 18. Further, a third electromagnetic valve V3 is arranged in the bypass portion 15e. A fourth electromagnetic valve V4 is arranged in the second portion 15b at a position between the portion branched to the heat exchanger 18 and the portion branched to the bypass portion 15e. The third and fourth electromagnetic valves V3 and V4 function as a switching means used to switch between a state in which the heat medium that has passed through the heat exchanger 11a or the bypass portion 15d is supplied to the heat exchangers 18 and a state in which the heat medium bypasses the heat exchangers 18.

A controller 30 includes a microcomputer (not shown). The temperature sensor 23 and the pressure sensors 26 are electrically connected to the input side of the controller 30. The compressor 13, the pressure regulation valve 22, the motor 28, the pump 29, the valves 21, and the first to fourth electromagnetic valves V1, V2, V3, and V4 are electrically connected to the output side of the controller 30. The compressor 13, the pressure regulation valve 22, the motor 28, the pump 29, the valves 21, and the first to fourth electromagnetic valves V1, V2, V3, and V4 are controlled based on command signals provided from the controller 30.

The controller 30 controls the first and second electromagnetic valves V1 and V2 in a manner that the heat medium is supplied to the heat exchanger 11a during operation of the fuel cell 11. The controller 30 detects the temperature of hydrogen supplied to the fuel cell 11 based on a detection signal provided from the temperature sensor 23. When the temperature is lower than or equal to a predetermined temperature, the controller 30 controls the third and fourth electromagnetic valves V3 and V4 in a manner that the heat medium that has been used to cool the fuel cell 11 is supplied to the heat exchanger 18 of each hydrogen storage tank 12. In the preferred embodiment, the predetermined temperature is set at a temperature in which water on the hydrogen reaction surface of the fuel cell 11 freezes.

The controller 30 detects the pressure in each hydrogen storage tank 12 based on a detection signal provided from each pressure sensor 26. When the pressure in the tank main body 16 of any one of the hydrogen storage tank 12 is greater than or equal to a first set pressure, the controller 30 opens the valve 21 corresponding to that hydrogen storage tank 12. When the pressure in at least one hydrogen storage tank 12 is lower than the first set pressure, the controller 30 controls the third and fourth electromagnetic valves V3 and V4 in a manner that the heat medium that has been used to cool the fuel cell 11 is supplied to each heat exchanger 18.

Further, the controller 30 controls the third and fourth electromagnetic valves V3 and V4 in a manner that the heat medium that has been used to cool the fuel cell 11 is supplied to each heat exchanger 18 when the pressure in at least one hydrogen storage tank 12 is equal to the plateau pressure of the hydrogen storage alloy MH irrespective of a detection signal provided from the temperature sensor 23.

The operation of the fuel cell system 10 in the first embodiment will now be described.

When the ambient temperature of the fuel cell 11 is higher than or equal to a set temperature necessary to generate power, the fuel cell 11 starts to operate normally immediately after the fuel cell 11 is activated. When the ambient temperature is lower than the set temperature, the fuel cell 11 is first warmed before starting to operate normally. During normal operation, hydrogen is supplied from each hydrogen storage tank 12 to the anode of the fuel cell 11, and air pressurized to a predetermined pressure is supplied from the compressor 13 to the cathode of the fuel cell 11.

The fuel cell 11 generates power most efficiently at its optimum temperature (about 80° C.). However, power generation by the fuel cell 11 causes an exothermic reaction. Thus, the heat medium cooled by the radiator 14 is supplied to the heat exchanger 11a of the fuel cell 11. Further, in each hydrogen storage tank 12, the hydrogen storage alloy MH releases hydrogen and causes an endothermic reaction. The heat medium that is warmed after cooling the fuel cell 11 is supplied to the heat exchanger 18 of each hydrogen storage tank 12.

For the reasons described above, the controller 30 maintains the first and second electromagnetic valves V1 and V2 in the state in which the heat medium is supplied to the heat exchanger 11a and switches the third and fourth electromagnetic valves V3 and V4 based on a detection signal provided from the temperature sensor 23 and a detection signal provided from the pressure sensor 26 during normal operation of the fuel cell 11. When the pressure in each hydrogen storage tank 12 is lower than the first set pressure, the controller 30 determines that the hydrogen storage alloy MH needs to be heated and thus switches the third and fourth electromagnetic valves V3 and V4 to the state in which the heat medium that has been used to cool the fuel cell 11 is supplied to each heat exchanger 18. Further, when the pressure each of the hydrogen storage tanks 12 is greater than or equal to a second set pressure, the controller 30 determines that the hydrogen storage alloy MH does not need to be heated and thus switches the third and fourth electromagnetic valves V3 and V4 to the state in which the heat medium bypasses the heat exchanger 18 of each hydrogen storage tank 12.

The controller 30 detects the pressure in each hydrogen storage tank 12 based on a detection signal provided from each pressure sensor 26. The controller 30 determines that a hydrogen storage tank 12 has been charged with hydrogen when its pressure is greater than or equal to the first set pressure and thus opens the valve 21 for that hydrogen storage tank 12. When the pressure in every one of the hydrogen storage tanks 12 is lower than the first set pressure after continuous heating with the heat medium for a predetermined time, the controller 30 determines that each hydrogen storage tank 12 needs to be charged with hydrogen, and drives a notification means (e.g. a display unit such as a lamp).

When each hydrogen storage tank 12 is charged with hydrogen, a coupler of a dispenser in the hydrogen station is connected to the hydrogen inlet 24a. A pressure difference between a hydrogen cylinder of the hydrogen station and each hydrogen storage tank 12 charges each hydrogen storage tank 12 with hydrogen. In this case, the hydrogen storage alloy MH in each hydrogen storage tank 12 stores hydrogen while causing an exothermic reaction. Thus, the hydrogen storage alloy MH must be cooled with the heat medium when charging hydrogen.

For the reasons described above, when each hydrogen storage tank 12 is charged with hydrogen, the controller 30 switches the first and second electromagnetic valves V1 and V2 in a manner that the heat medium bypasses the heat exchanger 11a of the fuel cell 11 and is supplied to the second portion 15b, and switches the third and fourth electromagnetic valves V3 and V4 in a manner that the heat medium flowing through the second portion 15b is supplied to the heat exchanger 18 of each hydrogen storage tank 12. As a result, the heat medium cooled by the radiator 14 is directly supplied to the heat exchanger 18 of each hydrogen storage tank 12 so that the hydrogen storage alloy MH in each hydrogen storage tank 12 is efficiently cooled. As a result, the storing reaction of hydrogen in the hydrogen storage alloy MH progresses smoothly.

When each hydrogen storage tank 12 is fully charged with hydrogen at a pressure higher than the plateaus pressure of the hydrogen storage alloy MH and higher than the equilibrium pressure of the hydrogen storage alloy MH corresponding to the temperature within each hydrogen storage tank 12, hydrogen charged in the space of each hydrogen storage tank 12 is supplied to the fuel cell 11. In this case, the pressure in each hydrogen storage tank 12 is greater than or equal to the pressure necessary to supply hydrogen to the fuel cell 11 (first set pressure). In the fuel cell system with the conventional structure, each hydrogen storage tank 12 is not heated by a heat medium. The controller 30 of the present invention switches the third and fourth electromagnetic valves V3 and V4 to the state in which the heat medium that has been used to cool the fuel cell 11 is supplied to each heat exchanger 18 when the temperature of hydrogen supplied to the fuel cell 11 is lower than or equal to a predetermined temperature even if the pressure in each hydrogen storage tank 12 is greater than or equal to the first set pressure. As a result, each hydrogen storage tank 12 is heated using the heat medium. The temperature of hydrogen supplied to the fuel cell 11 is prevented from becoming excessively low.

When the pressure in each hydrogen storage tank 12 is substantially equal to the plateau pressure of the hydrogen storage alloy MH, the controller 30 switches the third and fourth electromagnetic valves V3 and V4 to the state in which the heat medium that has been used to cool the fuel cell 11 is supplied to each heat exchanger 18 irrespective of the temperature of hydrogen supplied to the fuel cell 11. In this case, even if the heat medium is continuously supplied to each heat exchanger 18, the pressure in each hydrogen storage tank 12 does not rise sharply.

The first embodiment has the advantages described below.

(1) When the temperature of hydrogen supplied to the fuel cell 11 is lower than or equal to the predetermined temperature, the controller 30 controls the third and fourth electromagnetic valves V3 and V4 in a manner that the heat medium that has been used to cool the fuel cell 11 is supplied to each heat exchanger 18 in each hydrogen storage tank 12. As a result, the heat medium that has been used to cool the fuel cell 11 is supplied to each heat exchanger 18 and is used to heat each hydrogen storage tank 12. Thus, the temperature of the hydrogen supplied from each hydrogen storage tank 12 to the fuel cell 11 is prevented from becoming excessively low. As a result, the power generation efficiency of the fuel cell 11 is prevented from being lowered when the operation temperature of the fuel cell 11 decreases. Further, water on the hydrogen reaction surface is prevented from freezing and the hydrogen passage does not close.

(2) The predetermined temperature is set as the temperature at which water on the hydrogen reaction surface of the fuel cell 11 freezes. This prevents the temperature of hydrogen supplied from each hydrogen storage tank 12 from decreasing to a temperature at which water on the hydrogen reaction surface of the fuel cell 11 freezes. Thus, water on the hydrogen reaction surface does not freeze, and the hydrogen passage of the fuel cell 11 does not close. As a result, the fuel cell 11 is prevented from generating power in an abnormal manner.

(3) When the pressure in each hydrogen storage tank 12 is equal to the plateau pressure of the hydrogen storage alloy MH, the controller 30 controls the third and fourth electromagnetic valves V3 and V4 in a manner that the heat medium that has been used to cool the fuel cell 11 is supplied to each heat exchanger 18 irrespective of the temperature of hydrogen supplied to the fuel cell 11. More specifically, the third and fourth electromagnetic valves V3 and V4 are controlled in a manner that the heat medium that has been used to cool the fuel cell 11 is supplied to each heat exchanger 18 after hydrogen charged in the space of each hydrogen storage tank 12 at a high pressure during charging is supplied to the fuel cell 11. This simplifies the control compared to when the third and fourth electromagnetic valves V3 and V4 are controlled based on a temperature detected by the temperature sensor 23.

(4) Hydrogen is supplied from each hydrogen storage tank 12 to the fuel cell 11 through the common pipe 20. Further, the temperature sensor 23 for detecting the temperature of hydrogen supplied to the fuel cell 11 is arranged on the pipe 20 downstream from the connection portion 20a leading to each hydrogen storage tank 12. With this structure, the temperature is detected at a position closer to the fuel cell 11 than when the temperature sensor is arranged in each hydrogen storage tank 12. This enables the temperature of hydrogen supplied to the fuel cell 11 to be detected with higher accuracy.

(5) The pressure regulation valve 22 for adjusting the pressure of hydrogen supplied to the fuel cell 11 is arranged on the pipe 20 downstream from the connection portion 20a leading to each hydrogen storage tank 12. This simplifies the control compared to when the pressure regulation valve 22 is arranged in each hydrogen storage tank 12.

(6) Each hydrogen storage tank 12 includes the valve 21 and the pressure sensor 26 for detecting the pressure in the hydrogen storage tank 12. With this structure, the valve 21 of only the hydrogen storage tank 12 of which internal pressure is lower than the first set pressure is closed. Even when a certain hydrogen storage tank 12 becomes nearly empty before the other hydrogen storage tanks 12, hydrogen is smoothly supplied from the other hydrogen storage tanks 12 to the fuel cell 11.

(7) The supply of the heat medium from each hydrogen storage tank 12 to the heat exchanger 18 is controlled using the third and fourth electromagnetic valves V3 and V4 in a manner that the heat medium is supplied to all the hydrogen storage tanks 12 or the supply of the heat medium is stopped. This simplifies the control compared to when the third and fourth electromagnetic valves V3 and V4 are arranged in each hydrogen storage tank 12.

(8) The space of the tank main body 16 unoccupied by the hydrogen storage alloy MH in the fully-charged state of each hydrogen storage tank 12 is charged with hydrogen at a pressure higher than the plateau pressure of the hydrogen storage alloy MH and higher than the equilibrium pressure of the hydrogen storage alloy MH. This enables a larger amount of hydrogen to be stored in the hydrogen storage tank 12 compared to when the hydrogen storage tank 12 is charged with hydrogen at the plateau pressure of the hydrogen storage alloy MH.

### Second Embodiment

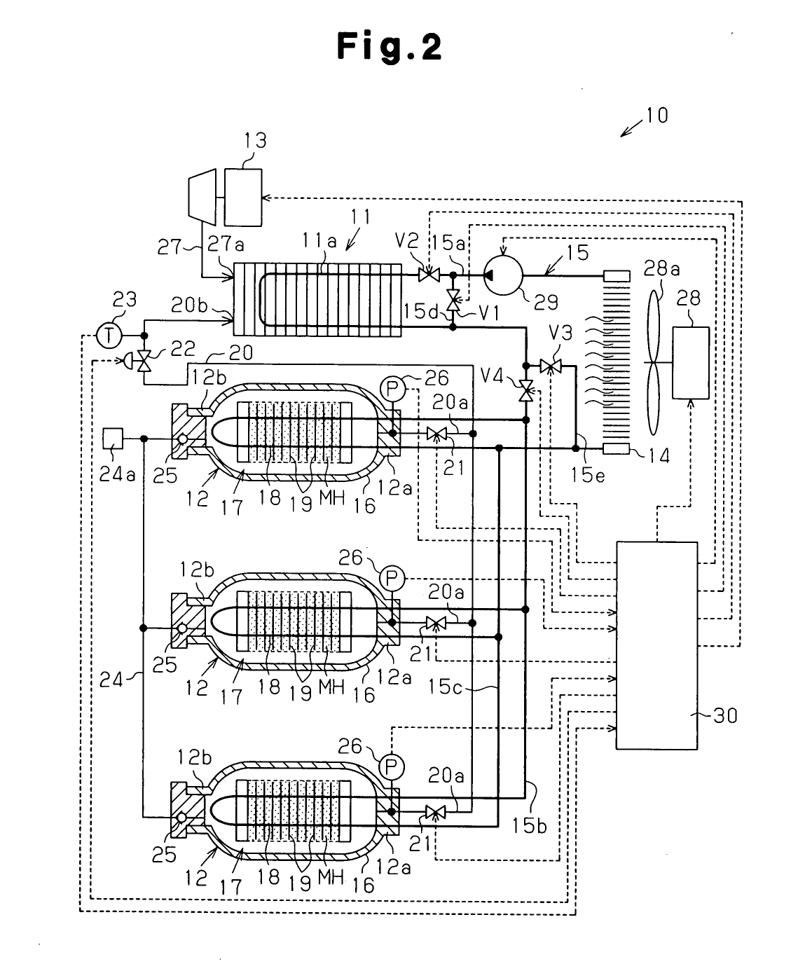

A fuel cell system 10 according to a second embodiment of the present invention will now be described with reference to FIG. 2. The components in the second embodiment that are the same as in the first embodiment will not be described in detail.

As shown in FIG. 2, each hydrogen storage tank 12 has a hydrogen inlet and a hydrogen outlet respectively arranged at opposite ends 12a and 12b of a tank main body 16. Each hydrogen storage tank 12 has a heat medium inlet and a heat medium outlet and the hydrogen outlet both arranged at the end 12a of the tank main body 16. A pipe 20 is connected to the hydrogen outlet side end 12a of each hydrogen storage tank 12 by a connection portion 20a. A pressure sensor 26 is arranged in each connection portion 20a to detect the pressure in the corresponding hydrogen storage tank 12.

In the hydrogen storage tanks 12 of the first embodiment, the heat medium heats the vicinity of the hydrogen outlet at the end 12a after the heat medium supplied to the heat exchanger 18 heats the hydrogen storage alloy MH. Heat is removed from the heat medium when the heat medium heats the hydrogen storage alloy MH. Thus, the hydrogen gas in the vicinity of the hydrogen outlet at the end 12a may not be sufficiently heated. However, in this embodiment, the vicinity of the hydrogen outlet in each hydrogen storage tank 12 is heated before the hydrogen storage alloy MH is heated. Thus, the hydrogen gas in the vicinity of the hydrogen outlet is sufficiently heated.

The second embodiment has the advantages described below.

(9) The heat medium supplied to the heat exchanger 18 heats the hydrogen storage alloy MH after heating the vicinity of the hydrogen outlet at the end 12a of each hydrogen storage tank 12. Thus, the vicinity of the hydrogen outlet of each hydrogen storage tank 12 is sufficiently heated. As a result, hydrogen supplied from each hydrogen storage tank 12 to the fuel cell 11 is easily heated.

(10) Each hydrogen storage tank 12 has the hydrogen inlet and the hydrogen outlet arranged at the opposite ends 12a and 12b of the tank main body 16. This enables the diameter of the base of each hydrogen storage tank 12 to be reduced.

### Third Embodiment

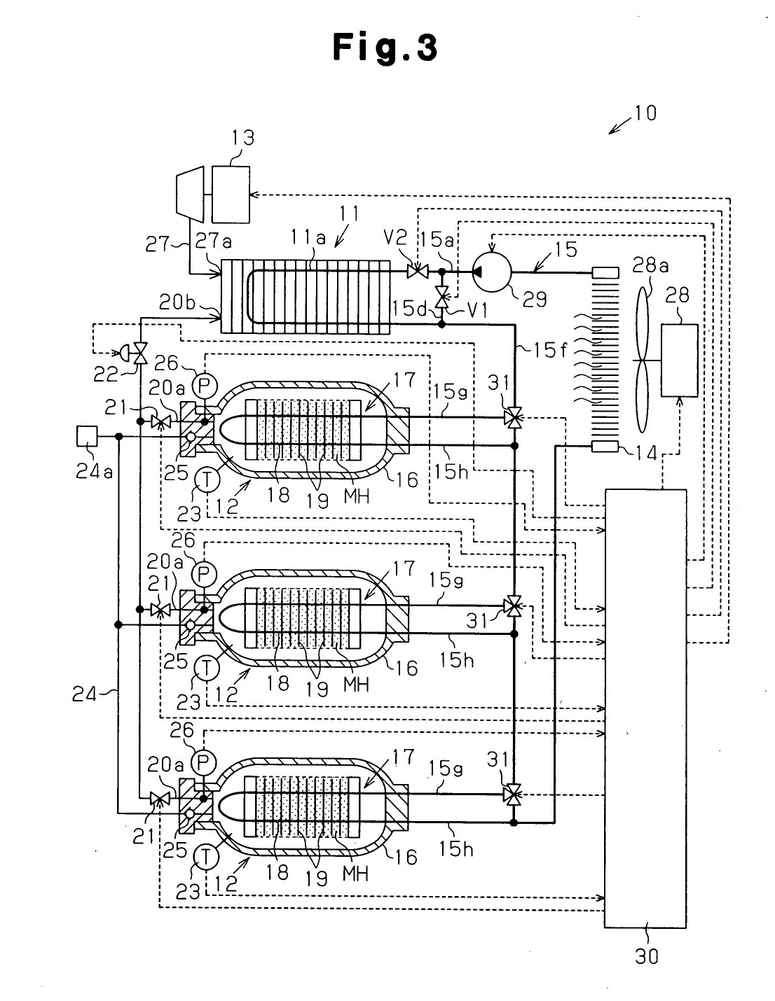

A fuel cell system 10 according to a third embodiment of the present invention will now be described with reference to FIG. 3. The components in the third embodiment that are the same as in the first and second embodiments will not be described in detail.

A heat medium passage 15 has a sixth portion 15f connecting an outlet of a heat exchanger 11a and an inlet of a radiator 14 instead of the second portion 15b in the first embodiment. A heat exchanger 18 in each hydrogen storage tank 12 has an inlet connected to a seventh portion 15g that branches from the sixth portion 15f. An electromagnetic three-way valve 31, which functions as a switching means, is arranged at each portion branching from the sixth portion 15f to the seventh portions 15g. Further, the heat exchanger 18 of each hydrogen storage tank 12 has an outlet connected to an eighth portion 15h that branches from the sixth portion 15f. Each electromagnetic three-way valve 31 is connected to a controller 30 and is switched between a state in which the heat medium flowing through the sixth portion 15f is supplied to the inlet of the heat exchanger 18 (first state) and a state in which the heat medium is supplied downstream along the sixth portion 15f from the branched portion (second state) based on a command output from the controller 30. In the preferred embodiment, each electromagnetic three-way valve 31 switches between a state in which the heat medium that has been used to cool the fuel cell 11 is supplied to each of the heat exchangers 18 sequentially and a state in which the heat medium is supplied to a selected one or two of the heat exchangers 18. Further, a temperature sensor 23 for detecting the temperature of hydrogen charged in the tank main body 16 is arranged in each hydrogen storage tank 12.

The operation of the fuel cell system 10 in the third embodiment will now be described.

First, the controller 30 selects the hydrogen storage tank 12 that needs to be heated based on the detection signals from of the temperature sensors 23 and pressure sensors 26. Next, the controller 30 switches each electromagnetic three-way valve 31 in a manner that the heat medium that has been used to cool the fuel cell 11 is supplied to the heat exchanger 18 of the selected hydrogen storage tank 12. When the electromagnetic three-way valves 31 are switched in this manner, the electromagnetic three-way valve 31 corresponding to the hydrogen storage tank 12 that needs to be heated is set in the first state and the electromagnetic three-way valves 31 that do not need to be heated are maintained in the second state.

The third embodiment has the advantages described below.

(11) The controller 30 selects the hydrogen storage tank 12 that needs to be heated and controls each electromagnetic three-way valve 31 in a manner that the heat medium that has been used to cool the fuel cell 11 is supplied only to the heat exchanger 18 in the selected hydrogen storage tank 12. In this case, the hydrogen storage alloy MH and hydrogen in the hydrogen storage tank 12 that needs to be heated are efficiently heated. As a result, the temperature of hydrogen supplied to the fuel cell 11 increases in a shorter time as compared with the above embodiments.

(12) After the heat medium is cooled by the radiator 14, the electromagnetic three-way valves 31 are used to switch between a state in which the heat medium sequentially passes through each of the hydrogen storage tanks 12 and a state in which the heat medium passes through only selected ones of the hydrogen storage tank 12. In this case, based on detection signals of the temperature sensor 23 and pressure sensor 26 of each hydrogen storage tank 12, the traveling route of the heat medium is changed to optimize the state in each hydrogen storage tank 12. This enables the hydrogen storage alloy MH in each hydrogen storage tank 12 to be heated and cooled easily and optimally.

The above embodiments may be modified in the following forms.

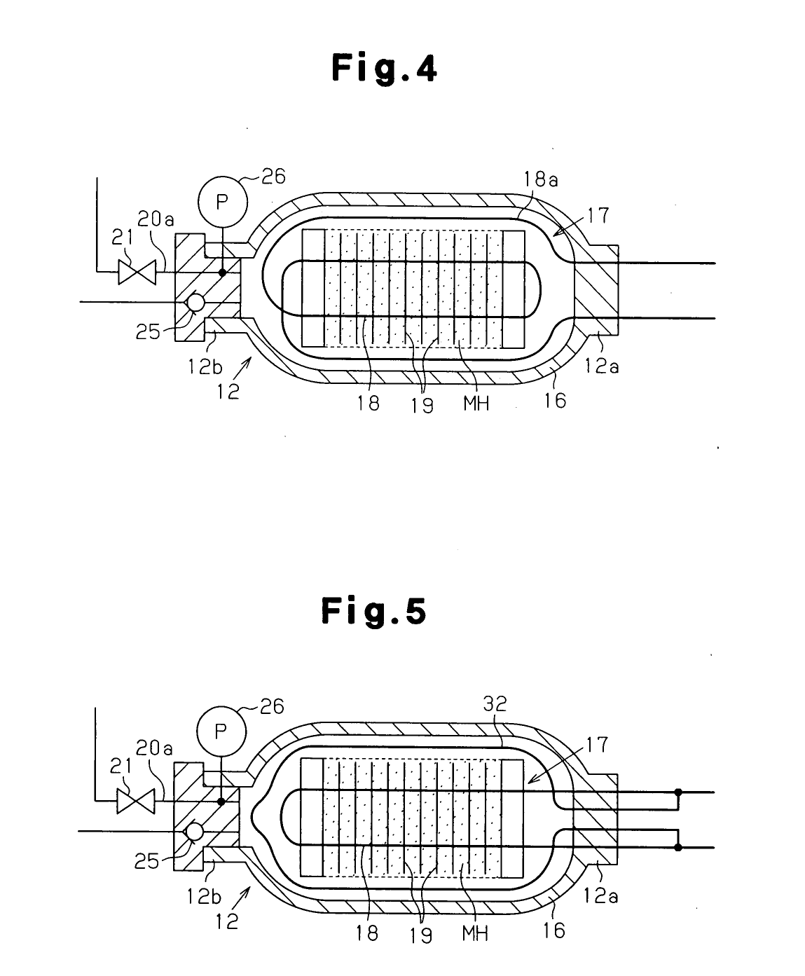

In the second embodiment, the structure of each heat exchanger 18 may be changed to a structure shown in FIG. 4. As shown in FIG. 4, a heat medium pipe 18a, which forms the heat exchanger 18, extends along the outer side of the hydrogen storage unit 17 and then into the hydrogen storage unit 17 from the vicinity of a hydrogen outlet. The heat medium pipe 18a is bent backward at the side opposite to the hydrogen outlet to extend through the hydrogen storage unit 17. Then, the heat medium pipe 18a extends again along the outer side of the hydrogen storage unit 17. In this case, the hydrogen in the tank main body 16 is heated before the hydrogen storage alloy MH is heated. This structure easily heats hydrogen supplied from each hydrogen storage tank 12 to the fuel cell 11.

In the second embodiment, the structure of each heat exchanger 18 may be changed to a structure shown in FIG. 5. As shown in FIG. 5, a heat exchanger 32 for heating hydrogen that fills the space in the tank main body 16 is arranged in the hydrogen storage tank 12 separately from a heat exchanger 18 that heats the hydrogen storage unit 17. In this case, the heat medium flowing through the heat exchanger 32 is used to heat only hydrogen. This structure heats hydrogen in the hydrogen storage tank 12 more efficiently as compared with the structure shown in FIG. 4.

In the above embodiments, the temperature sensor 23 for detecting the temperature of hydrogen may be arranged in the fuel cell 11. Further, a structure for detecting the temperature difference between the cathode (air pole) and the anode (hydrogen pole) may be used instead of the temperature sensor 23 as a temperature detection means.

In the above embodiments, the predetermined temperature for determining whether the heat medium that has been used to cool the fuel cell 11 is supplied to the heat exchanger 18 may be higher than the temperature at which water existing on the hydrogen reaction surface of the fuel cell 11 freezes (e.g. 5 to 10° C.).

In the above embodiments, instead of the structure for simultaneously supplying the fuel cell 11 with hydrogen from all of the hydrogen storage tanks 12 of which pressure in the tank main body 16 is greater than or equal to the first set pressure, a structure for supplying hydrogen sequentially from the hydrogen storage tanks 12 may be used. For example, the controller 30 may store in a memory the period of time during which hydrogen is supplied from each hydrogen storage tank 12, and the hydrogen storage tank 12 from which hydrogen is supplied to the fuel cell 11 may be sequentially switched whenever the supply time exceeds a predetermined time.

In the above embodiments, a valve may be arranged in a branch pipe for each hydrogen storage tank 12, and hydrogen gas may be sequentially charged into each hydrogen storage tank 12 in a manner that hydrogen gas is charged into one hydrogen storage tank 12 at a time.

In the above embodiments, the pressure in the hydrogen storage tank 12 that is fully charged with the hydrogen gas may be greater than or may be smaller than 35 MPa. When the hydrogen storage tank 12 is a hybrid tank, the pressure in the hydrogen storage tank 12 in the fully charged state is preferably equal to or greater than 5 MPa.

In the above embodiments, the fuel cell 11 may be, for example, a phosphoric-acid fuel cell or an alkaline fuel cell. The heat medium may be, for example, a fluid such as water.

In the above embodiments, the first to fourth electromagnetic valves V1, V2, V3, and V4 may be changed to electromagnetic three-way valves. The number of the hydrogen storage tanks 12 is not limited to three and may be two or less or four or more.

In the above embodiments, the hydrogen storage alloy MH may be changed to a hydrogen storage member, such as activated carbon fibers or a single carbon nanotube. Further, the fuel cell system 10 does not have to be installed in a fuel cell driven automobile and may be a fuel cell system for a mobile body other than a vehicle or a fuel cell system installed in a cogeneration system used in houses.

1. A fuel cell system in which hydrogen is supplied to a fuel cell from a hydrogen storage tank containing a hydrogen storage member in a tank main body, a heat medium that has cooled the fuel cell is used to heat the hydrogen storage member, and pressure in the tank main body is maintained to be greater than or equal to the pressure necessary to supply hydrogen to the fuel cell, the fuel cell system comprising:
a heat exchanger arranged in the hydrogen storage tank;
a heat medium passage for supplying the heat medium to the heat exchanger;
a temperature detection means for detecting temperature of the hydrogen supplied to the fuel cell;
a switching means, arranged on the heat medium passage, for switching between a state in which the heat medium that has cooled the fuel cell is supplied to the heat exchanger and a state in which the heat medium bypasses the heat exchanger; and
a control means for controlling the switching means based on a signal provided from the temperature detection means;
wherein the control means controls the switching means so that the heat medium that cooled the fuel cell is supplied to the heat exchanger when the temperature of the hydrogen supplied to the fuel cell is less than or equal to a predetermined temperature.

2. The fuel cell system according to claim 1, wherein the predetermined temperature is set at a temperature in which water on a hydrogen reaction surface of the fuel cell freezes.

3. The fuel cell system according to claim 1, wherein hydrogen is supplied from a plurality of hydrogen storage tanks, with hydrogen supplied from each hydrogen storage tank to the fuel cell through a common pipe, and the temperature detection means detects the temperature of the hydrogen flowing between the fuel cell and a portion of the pipe connected to each hydrogen storage tank.

4. The fuel cell system according to claim 1, wherein the heat medium that has cooled the fuel cell is supplied to the hydrogen storage member after passing through a vicinity of a hydrogen outlet of the hydrogen storage tank.

5. The fuel cell system according to claim 3, wherein the switching means is switchable between a state in which the heat medium that has cooled the fuel cell is sequentially supplied to each heat exchanger and a state in which the heat medium is supplied to a specific one of the heat exchangers.

6. The fuel cell system according to claim 3, wherein each hydrogen storage tank has a valve, and the control means controls the valve of each hydrogen storage tank to open and close in a manner that a residual amount of hydrogen in each of the hydrogen storage tanks is the same when supplying the fuel cell with hydrogen.

7. The fuel cell system according to claim 6, wherein the control means controls the valve of each hydrogen storage tank to open and close in a manner that when the fuel cell has been supplied with hydrogen from one of the hydrogen storage tanks for a predetermined time, another one of the hydrogen storage tanks then supplies the fuel cell with hydrogen.

8. The fuel cell system according to claim 1, wherein the fuel cell system is installed in a fuel cell driven automobile.

9. A fuel cell system for supplying hydrogen to a fuel cell from a hydrogen storage tank containing a hydrogen storage member in the tank in which a heat medium is used for cooling the fuel cell, the fuel cell system comprising:
a heat exchanger disposable in the hydrogen storage tank;
a heat medium passage for supplying the heat medium to the heat exchanger;
a temperature detector which detects temperature of the hydrogen when supplied to the fuel cell;
a switch arranged on the heat medium passage which switches between a state in which the heat medium after cooling the fuel cell is supplied to the heat exchanger and a state in which the heat medium bypasses the heat exchanger; and
a controller which controls the switch based on a signal provided from the temperature detector, wherein the controller controls the switch so that the heat medium after cooling the fuel cell is supplied to the heat exchanger when the temperature of the hydrogen supplied to the fuel cell is less than or equal to a predetermined temperature.

10. The fuel cell system according to claim 9, wherein the predetermined temperature is set at a temperature in which water on a hydrogen reaction surface of the fuel cell freezes.

11. The fuel cell system according to claim 9, wherein the hydrogen is supplied from a plurality of hydrogen storage tanks with hydrogen supplied from each hydrogen storage tank to the fuel cell through a common pipe, and the temperature detector detects the temperature of the hydrogen flowing between the fuel cell and a portion of the pipe connected to each hydrogen storage tank.

12. The fuel cell system according to claim 9, wherein the heat medium after cooling the fuel cell is supplied to the hydrogen storage member after passing through a vicinity of a hydrogen outlet of the hydrogen storage tank.

13. The fuel cell system according to claim 11, wherein the switch is switchable between a state in which the heat medium after cooling the fuel cell is sequentially supplied to each heat exchanger and a state in which the heat medium is supplied to a specific one of the heat exchangers.

14. The fuel cell system according to claim 11, wherein each hydrogen storage tank has a valve, and the controller controls the valve of each hydrogen storage tank to open and close in a manner that a residual amount of hydrogen in each of the hydrogen storage tanks is the same when supplying the fuel cell with hydrogen.

15. The fuel cell system according to claim 14, wherein the controller controls the valve of each hydrogen storage tank to open and close in a manner that when the fuel cell has been supplied with hydrogen from one of the hydrogen storage tanks for a predetermined time, another one of the hydrogen storage tanks then supplies the fuel cell with hydrogen.

16. The fuel cell system according to claim 9, wherein the fuel cell system is adapted for installation in a fuel cell driven automobile.
